(19) United States
(12) Patent Application Publication
(10) Pub. No.: US 2005/0152751 A1
(43) Pub. Date: Jul. 14, 2005

(54) Method for regulating the flow of powder carried by an air stream and device therefor

(76) Inventors: Jose Rodrigues, Saint-Guillaume (FR); Flavien Dobrowolski, Sinard (FR)

Correspondence Address: CANTOR COLBURN, LLP, 55 GRIFFIN ROAD SOUTH, BLOOMFIELD, CT, 06002, US

(21) Appl. No.: 10/513,422

(22) PCT Filed: May 10, 2003
(86) PCT No.: PCT/FR02/01589

(51) Int. Cl. B05B 7/14; B65G 51/16

(52) U.S. Cl. 406/12

(57) ABSTRACT

The invention concerns a method for regulating flow of powder in a device including an injector (2) sucking the powder (6) from a container (4) by Venturi effect, the injector (2) receiving at its intake an injection air flow (Dai), and, proximate to an outlet, a dilution air flow (Dad). Two proportional electromagnetic valves (12, 13) are arranged respectively on the injection air intake (7) and on the dilution air intake (8). Said electromagnetic valves (12, 13) are controlled by an adjusting module (11) which receives a powder flow setpoint (Dp) and which determines injection air (Dai) and dilution air (Dad) flow rates taking into account stored coefficients. (A, B) and a minimum total air flow (Dam) to be observed, based on the formula Dp/A.Dai B.Dad. The invention is useful for feeding a spraying appliance (10) with paint or any other powder coating product.

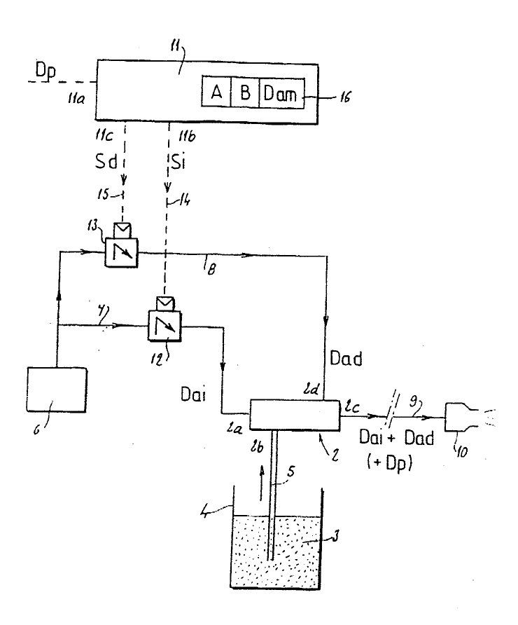

The present invention relates to a method for regulating the flow rate of powder in a device for delivering a flow of powder transported by a flow of air. This method more particularly applies to a “powder pump” system with suction of the powder from a recipient by the Venturi effect through an injector receiving at its inlet a flow of injection air and, with injection, near the outlet of the injector, an additional flow of air, known as dilution air, which is added to the flow of injection air. Such a system is, in particular, applicable to the supply, via a conduit of a substantial length, of a paint spraying apparatus or other powder coating product, for example for supplying spray-painting robots used in the automobile industry.

In this kind of system, a main flow of air, called injection air, allows the powder to be sucked up from a recipient, such as a boat filled with powder, by means of an injector using the Venturi effect. The powder flow rate resulting from this suction increases with the injection air flow rate, hence with the supply pressure.

However, in order to transport the powder over a long distance, without pulsing, the air speed within the supply conduit of the spraying apparatus must be greater than around 10 m/s, whereas, for low mass flows of powder, typically below 6 kg/hr, the air speed is less than the aforementioned value. Hence, at the outlet of the “powder pump”, an additional flow of air called dilution air is injected, in order to bring the speed of the air in the supply conduit of the spraying apparatus back up again.

The problem that is found here is that the flow of dilution air causes the powder flow rate to fall, for a constant flow rate of injection air. This phenomenon therefore needs to be compensated for by increasing the flow rate of injection air in order to maintain the desired powder flow rate. A special regulation system, capable of automatically adjusting the injection air and dilution air flow rates to obtain the desired powder flow rate, therefore becomes necessary in order to ensure the correct operation of the “powder pump”.

Such “powder pumps” are already described in numerous documents, for example in patent applications FR 2 680 416, EP 0 636 420, EP 0 686 430, WO 00/10726and WO 00/10727. Generally speaking, as regards the regulation systems, these documents propose closed-loop servocontrol systems which use, on the one hand, given setting values, and on the other, instantaneous real values delivered by pressure or flow-rate sensors, for the air and/or for the powder, which sensors are disposed at various points in the device. This leads to relatively complicated and costly solutions.

In order to avoid the above drawbacks, a subject of the present invention is a method of regulation using a solution that is simplified and inexpensive and that obviates the need for any pressure and/or flow rate sensors for the automatic adjustment of the injection and dilution air flows, while still allowing an acceptable operation to be achieved, in other words obtaining the desired powder flow rate, without pulsing.

To this end, the invention relates to a method for regulating the flow rate of powder in a device for delivering a flow of powder transported by a flow of air, of the type defined in the introduction, in which:
the powder flow rate (Dp) is considered to be proportional to the injection air flow rate (Dai) and to the dilution air flow rate (Dad), according to the formula:
   Dp=A.Dai−B.Dad
a minimum value Dam of the total air flow rate (Dt=Dai+Dad), corresponding to a minimum speed of the air flow within the supply conduit, is chosen,
for a given setting value of the powder flow rate (Dp), the injection air flow rate (Dai) is deduced from the above formula by assuming initially that there is no dilution air:
   Dai=Dp/A
if the flow rate of injection air (Dai) thus determined is greater than the minimum flow rate (Dam), this value of injection air flow rate (Dai) is kept and the dilution air flow rate (Dad) is chosen to be zero, or
if the flow rate of injection air (Dai) thus determined is less than the minimum flow rate (Dam), it is assumed that dilution air is added such that Dam=Dai+Dad and Dai and Dad are deduced from the following formulae:
   Dai=(Dp+B.Dam)/(A+B)
   Dad=(A.Dam−Dp)/(A+B)
the values thus determined, for the injection air flow rate (Dai) and for the dilution air flow rate (Dad), are respectively converted into regulation signals for injection air flow and dilution air flow adjustment mechanisms placed in the air supply lines to the injector.

The invention thus provides a technical solution that, although based on empirical elements and admitting certain approximations, leads to results which have proved to be acceptable, with the advantage that all the pressure and/or flow sensors and the servo feedback loops associated with such sensors have been removed, the proposed solution being an open-loop regulation.

For the powder coating of parts that have a particularly complex form, for example having at least one deep cavity, it can be necessary for the operator to increase the flow level of dilution air so as to “accelerate” the powder particles at the exit of the powder spray gun nozzle. In other words, a minimum dilution air flow rate Dadm is imposed by the operator, even if the calculation previously described yields a zero value for this air flow rate.

In this case, the method of the invention will operate as described previously by adding Dadm to the value of Dad resulting from the calculation.

For example, in this latter case the method becomes:
the powder flow rate (Dp) is considered to be proportional to the injection air flow rate (Dai) and to the dilution air flow rate (Dad), according to the formula:
   Dp=A.Dai−B.Dad
a minimum value Dam of the total air flow rate (Dt=Dai+Dad), corresponding to a minimum speed of the air flow within the supply conduit, is chosen,
a minimum value Dadm of the dilution air flow rate is also chosen,
for a given setting value of the powder flow rate (Dp), the injection air flow rate (Dai) is deduced from the above formula by assuming initially that Dad=Dadm:
   Dai=(Dp+B.Dadm)/A
if the flow rate of the injection air (Dai) thus determined is greater than the minimum flow rate (Dam), this value of the injection air flow rate (Dai) is kept and the dilution air flow rate (Dad) is chosen to be equal to Dadm, or
if the flow rate of the injection air (Dai) thus determined is less than the minimum flow rate (Dam), it is assumed that dilution air is added such that Dam=Dai+Dad and that the value of the minimum dilution air flow rate Dadm is constant, then Dai and Dad are deduced from the following formulae:
   Dai=(Dp+B.(Dam+Dadm))/(A+B)
   Dad=(A.Dam−Dp)/(A+B)+Dadm
the values thus determined, for the injection air flow rate (Dai) and for the dilution air flow rate (Dad), are respectively converted into regulation signals for injection air flow and dilution air flow adjustment mechanisms placed in the air supply lines to the injector.

For the implementation of the method defined above, another subject of the present invention is a device for the injection and transport of powder, more particularly for supplying an apparatus for spraying paint or other powder coating product, this device essentially comprising a combination of:
an injector connected to an injection air supply line supplied from an external source, to a supply line of powder from a recipient and to a dilution air line supplied from an external source;
a first proportional electrovalve placed in the injection air supply line;
a second proportional electrovalve placed in the dilution air supply line;
a regulation module receiving the powder flow rate setting (Dp) and having outputs connected to the proportional electrovalves placed respectively in the injection air supply line and the dilution air supply line, the regulation module storing the proportionality coefficients (A and B) and the minimum total air flow rate (Dam), for determining, by taking the powder flow rate setting (Dp) into account, the flow rates of the injection air (Dai) and the dilution air (Dad) and for deducing from these the corresponding values of the regulation signals for the two proportional electrovalves.

In addition, it can be arranged that a minimum value for the dilution air flow rate be introduced into the regulation module.

The device thus formed has the advantage of using simple proportional electrovalves, which are standard parts conventionally used in the field of paint spraying (as opposed to the servo-motors proposed by several of the aforementioned documents of the prior art). Receiving the electrical signals generated by the regulation module that are a function of the values of the injection air and dilution air flow rates determined by these modules, the two electrovalves continually adapt the injection air and dilution air flows so as to obtain, at any given moment, the desired powder flow rate. It will be understood that use of such electrovalves further contributes to the simplicity and low cost of the system.

The invention will be better understood with the aid of the following description that makes reference to the appended schematic drawing showing an exemplary embodiment of this powder injection and transport device.

The single FIGURE of the drawing shows, in the form of a block diagram, such a device applied to the supply of a paint spraying device and implementing the method of regulating the powder flow that is a subject of the invention.

The Venturi effect injector, or “powder pump”, 2 is indicated in the drawing in a highly simplified form. This injector comprises an axial inlet for the main air 2a, or injection air inlet, and a side supply line for the powder 2b, together with a side supply line for additional, or dilution, air 2d near to its outlet 2c which is also axial.

The powder 3 to be sucked up is contained in a powder reservoir or boat 4 that is connected by a short suction conduit 5 to the powder side supply line 2b of the injector 2.

A source of compressed air 6 supplies a main air feed conduit 7 that connects to the injection air inlet 2a of the injector 2. The main air conduit 7 comprises a ‘T’ section outlet 8 that connects to the side supply line for additional air 2d and which thus forms a dilution air feed conduit to the injector 2.

The outlet 2c of the injector 2 forms the starting point for a supply conduit 9 of a spray gun 10, located at a substantially long distance on a paint spraying apparatus not shown in detail, in particular a spray painting robot.

Generally speaking, the powder 3 sucked up by the injector 2 is mixed with air in the latter, such that a flow of powder transported by an air flow is delivered to the outlet 2c of the injector 2 and then flows all along the conduit 9 in order to supply the spray gun 10.

In order to regulate the flow of powder delivered to the outlet 2c of the injector 2, an electronic regulation module 11 is provided; this receives a powder flow rate setting Dp at an input 11a.

The regulation elements also comprise a first proportional electrovalve 12 placed in the main air, or injection air, supply conduit 7 and a second proportional electrovalve 13 placed in the dilution air supply conduit 8.

The regulation module 11 comprises an output 11b connected, by an electrical link 14, to the first proportional electrovalve 12. This regulation module 11 comprises another output 11c connected, by an electrical link 15, to the second proportional electrovalve 13.

During operation, the regulation module 11, which receives the powder flow rate setting Dp, deduces from this the adjustment levels of the two proportional electrovalves 12 and 13 which correspond to the appropriate values of the injection air flow rate Dai and of the dilution air flow rate Dad. Referring to a specific practical example, the details of the mode of operation are as follows:

The powder flow rate Dp is taken, as a first approximation, to be proportional to the injection air flow rate Dai and to the dilution air flow rate Dad, according to the formula: Dp=A.Dai−B.Dad in which A and B are coefficients determined from measurements carried out on a Venturi effect injector 2 of the type concerned.

Additionally, in order to avoid pulsing of the powder flow Dp, the speed of the air in the supply conduit 9 of the spray gun 10 must be greater than 10m/s. For a conduit 9 about ten meters in length and with an internal diameter equal to 10 mm (as an example), this may be expressed by the equation: Dai+Dad≧3.4 m³/hr.

Starting from these equations, the process implemented in the regulation module 11 is therefore the following:
a minimum value Dam is chosen for the total air flow rate Dt=Dai+Dam, for example 3.4 m³/hr, where this value may be modified as a variable system parameter;
for a given powder flow rate Dp, the corresponding injection air flow rate Dai is deduced using the aforementioned formula initially assuming that there is no dilution air, such that:
   Dai=Dp/A
if the injection air flow rate Dai, thus determined, is greater than or equal to 3.4 m³/hr, the value of injection air flow rate Dai calculated above is applied and the value of the dilution air flow rate Dad is chosen to be zero (Dad=0);
on the other hand, if the injection air flow rate Dai determined as indicated above is less than 3.4 m³/hr, it is assumed that dilution air is added such that Dam=Dai+Dad, and Dai and Dad are deduced from the following formulae:
   Dai=(Dp+B.Dam)/(A+B)
   Dad=(A.Dam−Dp)/(A+B)

In order to perform the necessary calculations, the regulation module 11 comprises a memory 16 in which the values of the proportionality coefficients A and B are stored, together with the air flow minimum value Dam which is 3.4 m³/hr in the example chosen here.

The values thus found of Dai and Dad, for the injection air and dilution air flow rates, are still only approximate since they assume that the representative curves of the powder flow rate Dp as a function of the air flow rates Dai and Dad are linear, however these values are sufficient for the purposes of the invention.

From the values Dai and Dad of these air flow rates, the regulation module 11 deduces the corresponding regulation values for the two proportional valves 12 and 13. The regulation module 11 thus delivers, at its output 11b, a first regulation signal Si which is fed, via the link 14, to the first proportional electrovalve 12 for setting the injection air flow Dai admitted into the injector 2 by the main air supply conduit 7. In a similar manner, the regulation module 11 delivers, at its output 11c, a second regulation signal Sd which is fed, via the link 15, to the second proportional electrovalve 13 for setting the dilution air flow Dad admitted into the injector 2 by the side conduit 8.

Each proportional electrovalve 12 or 13 comprises, for example, an electromagnetic coil that displaces a mobile core having a pointed end pushing with more or less force against a membrane which thus acts as a flow restrictor. The degree of opening of each proportional electrovalve 12 or 13 can thus be modified, in a continuous fashion, between a zero value and a maximum value, the possibility of setting a zero air flow rate being important for the electrovalve 13 that controls the dilution air flow Dad, when the specifications of the method of the invention are taken into account.

Without straying from the scope of the invention as defined in the appended claims, the following variants in the application of the invention could be adopted:
adapting the powder flow regulation method according to the length of the section of conduit supplying the paint spraying apparatus, in particular by adjusting the minimum value of the total air flow rate from 3.4 m³/hr;
using any other type of proportional electrovalve;
applying the method and the device of the invention to the supply of any type of equipment using powder carried by a flow of air.

1. A method for regulating a flow rate of powder (Dp) in a device for delivering a flow of powder transported by a flow of air, with suction of the powder from a reservoir by a Venturi effect, through an injector receiving at an inlet a flow injection air (Dai) and with injection, near an outlet of the injector, of an additional flow of dilution air (Dad), which is added to the flow of injection air (Dai), for the supplying, via a conduit, an apparatus for spraying paint or other powder coating product, wherein:
the powder flow rate (Dp) is proportional to the injection air flow rate (Dai) and to the dilution air flow rate (Dad), according to the formula:
Dp=A.Dai−B.Dad
a minimum value Dam of a total air flow rate (Dt=Dai+Dad), corresponding to a minimum speed of the air flow within the supply conduit, is chosen,
for a given setting value of the powder flow rate (Dp), the injection air flow rate (Dai) is deduced from the above formula by assuming initially that there is no dilution air:
Dai=Dp/A
if the flow rate of injection air (Dai) thus determined is greater than the minimum flow rate (Dam), this value of injection air flow rate (Dai) is kept and the dilution air flow rate (Dad) is chosen to be zero, or
if the flow rate of injection air (Dai) thus determined is less than the minimum flow rate (Dam), it is assumed that dilution air is added such that Dam=Dai+Dad and Dai and Dad are deduced from the following formulae:
Dai=(Dp+B.Dam)/(A+B), Dad=(A.Dam−Dp)/(A+B)
the values thus determined, for the injection air flow rate (Dai) and for the dilution air flow rate (Dad), are respectively converted into regulation signals for injection air flow and dilution air flow adjustment mechanisms placed in the air supply lines to the injector.

2. The method as claimed in claim 1, wherein a minimum value of dilution air (Dadm) is introduced into the method.

3. A device for injection and transport of powder, for supplying an apparatus for spraying paint or other powder coating product, and implementing the method of claim 1 comprising:
an injector connected to an injection air supply line supplied from an external source, to a supply line of powder from a recipient and to a dilution air line supplied from an external source;
a first proportional electrovalve placed in the injection air supply line;
a second proportional electrovalve placed in the dilution air supply line;
a regulation module receiving the powder flow rate setting (Dp) and having outputs connected to the proportional electrovalves placed respectively in the injection air supply line and the dilution air supply line, the regulation module storing proportionality coefficients (A and B) and the minimum total air flow rate (Dam), for determining, by taking the powder flow rate setting (Dp) into account, the flow rates of the injection air (Dai) and the dilution air (Dad) and for deducing from these the corresponding values of regulation signals for the two proportional electrovalves.

4. The device as claimed in claim 3, wherein a minimum value of dilution air flow (Dadm) can be introduced into the regulation module.
